(19) United States
(12) Patent Application Publication
(10) Pub. No.: US 2023/0075805 A1
(43) Pub. Date: Mar. 9, 2023

(54) SYSTEM AND METHOD FOR GENERATING A PREDICTED DESIRED TARGET MARGIN OF A SELLER OF A REAL-ESTATE PROPERTY

(71) Applicant: STOA USA, INC., NORTH MIAMI BEACH, FL (US)

(72) Inventor: Or AGASSI, Tel Aviv (IL)

(73) Assignee: STOA USA, INC., NORTH MIAMI BEACH, FL (US)

(21) Appl. No.: 17/930,530

(22) Filed: Sep. 8, 2022

Related U.S. Application Data
(60) Provisional application No. 63/241,805, filed on Sep. 8, 2021.

(51) Int. Cl. G06Q 30/02; G06Q 50/16

(52) U.S. Cl. CPC G06Q 30/0206; G06Q 30/0201; G06Q 50/165

(57) ABSTRACT

A system and method for generating a predicted desired target margin of a seller of a real-estate property (REP), including: extracting at least a dataset that is associated with the seller of the at least a first REP, wherein the dataset includes at least one value that is associated with each parameter of a set of parameters related to at least one prior transaction of the seller; and determining a predicted target margin of the seller with respect to the sale of the at least a first REP based on the second data set.

### CROSS-REFERENCE TO RELATED APPLICATIONS

This application claims benefit of U.S. provisional patent application Ser. No. 63/241,805, filed Sep. 8, 2021, which is herein incorporated by reference.

### TECHNICAL FIELD

The present disclosure relates generally to real-estate assessment tools, and more specifically to a system and method for generating an offer for purchasing a real-estate property (REP) from a seller of the REP based on a predicted target margin of the seller.

### BACKGROUND

Even though advances in technology have become available in most industrial areas, the real-estate domain remains dependent on massive use of manual labor to perform tedious and costly tasks.

House flipping is a type of real estate investment strategy in which investors purchase properties with the goal of reselling them for a profit. Profit is generated either through the price appreciation that occurs as a result of a hot housing market and/or from developments and capital improvements to the property. Investors who employ these strategies face the risk of price depreciation in bad housing markets.

Investors who flip houses expect to generate a relatively high return from the houses purchased but may encounter cash-flow difficulties due to the nature of such strategies, which can require significant amounts of cash up front. Therefore, such investors typically use outsourced financing from different entities, such as banks, other financial institutes, or private lenders.

The loan process can be burdensome for an investor, who is often working on a hectic time frame. The complexity of the loan process is due to, among other reasons, the amount of time required by the lender for the evaluation of the value of the real-estate property for which the loan is required.

It would therefore be advantageous to provide a solution that would overcome the challenges noted above.

### DETAILED DESCRIPTION

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a method for generating a predicted desired target margin of a seller of a real-estate property (REP). The method includes: extracting at least a dataset that is associated with the seller of the at least a first REP, wherein the dataset includes at least one value that is associated with each parameter of a set of parameters related to at least one prior transaction of the seller; and determining a predicted target margin of the seller with respect to the sale of the at least a first REP based on the second data set.

Certain embodiments disclosed herein also include non-transitory computer readable medium having stored thereon instructions for causing a processing circuitry to perform a process for generating a predicted desired target margin of a seller of a real-estate property (REP), the process including: extracting at least a dataset that is associated with the seller of the at least a first REP, wherein the dataset includes at least one value that is associated with each parameter of a set of parameters related to prior transactions of the seller; and determining a predicted target margin of the seller with respect to the sale of the at least a first REP based on the second data set.

Certain embodiments disclosed herein also include a system for generating a predicted desired target margin of a seller of a real-estate property (REP) including a processing circuitry; and a memory, the memory containing instructions that, when executed by the processing circuitry, configure the system to: extract at least a dataset that is associated with the seller of the at least a first REP, wherein the dataset includes at least one value that is associated with each parameter of a set of parameters related to prior transactions of the seller; and determine a predicted target margin of the seller with respect to the sale of the at least a first REP based on the second data set.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is an illustrative diagram of a system utilized for generating a predicted target margin of a seller with regard to a real-estate property;

FIG. 2 is an illustrative block diagram of a server according to an embodiment; and

FIG. 3 shows an illustrative flowchart describing a method for generating a predicted desired target margin of a seller of an REP, according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

I have come to appreciate that different sellers (e.g., investors who flip houses) expect different returns on their investment, i.e., different margins, when making real-estate transactions. When there are different properties that have similar costs, characteristics, and require similar renovation time and renovation cost, when the properties are each being handled, e.g., owned, by two different sellers the expected margin, the expected return on investment each seller would not be identical. In addition, when a purchaser would like to buy a property from a seller, it must be understood that there is a minimum margin that the seller requires or he will not sell, and the buyer has a maximum price he is willing to pay or he will not buy. A sale, therefore, typically only occurs when there is an overlap between the price range extending from the minimum that the seller is willing to accept up through infinity and the maximum the buyer is willing to pay, extending down to zero. Within the resulting range, i.e., from the minimum that the seller will accept and the maximum the seller will pay, a meeting of the minds on a common price may be arrived at that will allow a sale to take place. Of course, the closer the price is to the minimum that the seller will accept the happier the buyer will be while, conversely, the closer the price is to the maximum the buyer is willing to pay the happier the seller will be. Therefore, from the point of view of the buyer it would be advantageous to have a prediction of a target margin of a specific seller of a REP with respect to the sale of the REP that would be acceptable to the seller such that an offer may be extended that would be acceptable by the seller and yet, at the same time, would enable the buyer to achieve a profit in the future.

To this end, I have developed a method that endeavors to predict a required margin of a seller of an REP. The margin may be expressed as a percentage or as a specified price. More specifically, the method includes: extracting at least a first dataset that is associated with a REP from at least a first source, upon receiving a request to determine a margin that might be used by a buyer as a basis for making an offer for purchasing the REP; extracting at least a second dataset that is associated with the seller of the REP, the second dataset includes one or more values that are associated with a set of predetermined parameters; determining a predicted target margin of the seller with respect to a potential sale of the REP; and generating a suggestion that might be used by a potential buyer to offer for purchasing the REP based on the at least a first dataset and the predicted desired target margin.

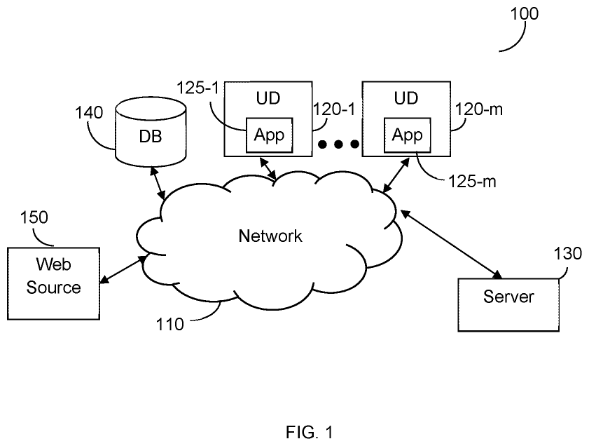

FIG. 1 is an illustrative diagram 100 of a system utilized for generating a predicted target margin of a seller with regard to a real-estate property (REP) wherein such predicted target margin could be used to influence the thinking of a potential buyer of the REP with regards to what he might offer the seller for the REP. To that end, the system may also generate a suggestion that might be used by a potential buyer as the basis of an offer for purchasing the REP, the suggestion being based on the at least a first dataset and the predicted desired target margin. Note that no actual offer is made and there is no interaction required between multiple parties, i.e., between any buyer and any seller.

As shown in FIG. 1, a network 110 may be the Internet, the world-wide-web (WWW), a local area network (LAN), a wide area network (WAN), a metro area network (MAN), and other networks capable of enabling communication between the elements of the system 100.

Optionally, one or more user devices 120-1 through 120-m, where m is an integer equal to or greater than 1, hereinafter referred to as user device 120 for simplicity, are further connected to the network 110. A user device 120 may be, for example, a personal computer (PC), a personal digital assistant (PDA), a mobile phone, a smart phone, a tablet computer, an electronic wearable device (e.g., glasses, a watch, etc.) and other kinds of wired and mobile appliances, equipped with browsing, viewing, capturing, storing, listening, filtering, and managing capabilities enabled as further discussed herein below.

Each user device 120 may further include a software application (App) 125 installed thereon. The software application 125 may be downloaded from an application repository, such as the Apple AppStore®, Google Play®, or any repositories hosting software applications. The application 125 may be pre-installed on the user device 120. In one embodiment, the application 125 is a web-browser.

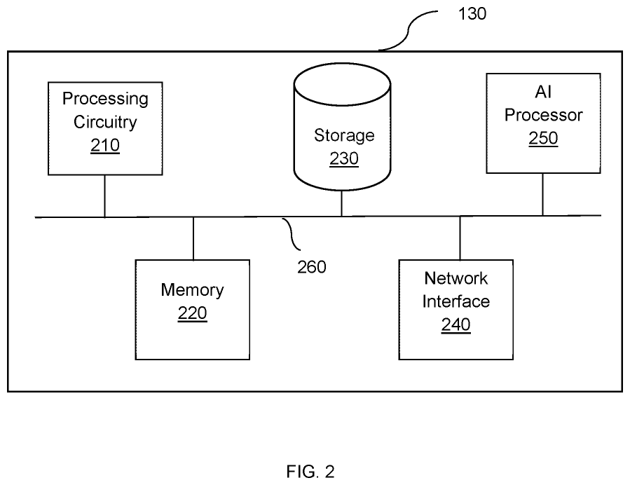

A server 130 is connected, over the network 110, to each user device 120 and can communicate therewith using the application 125 via the network 110. In an embodiment, the server 130 may be a physical device as illustrated in FIG. 2. In another embodiment, the server 130 may be virtual machine operable in a cloud computing platform. It should be noted that only one server 130 and one application 125 are discussed herein merely for the sake of simplicity. However, the embodiments disclosed herein are applicable to a plurality of user devices that can communicate with the server 130 via the network 110.

Also communicatively connected to the network 110 is a database (DB) 140 that may be used for storing one or more datasets related to property transactions, data extracted from regulatory data sources and/or tax authorities, geographic information systems (GISs), data related to the parties (e.g., seller, buyer) of a property transaction, and more. In the embodiment illustrated in FIG. 1, the server 130 communicatively communicates with the database 140 through the network 110.

One or more web sources 150 may be communicatively connected to the network 110. The web sources 150 may include, for example, governmental websites via the network, real-estate comparison websites (e.g., Zillow®), multiple listing sources and the like.

The system and methods described herein are used for determining a predicted target margin of the seller with respect a potential sale of the REP; and possibly also generating a suggestion that might be used by a potential buyer as an offer or basis therefor for purchasing the REP based on the at least a first dataset and the predicted desired target margin. The generated acceptable margin is determined based on multiple parameters of the seller, while a suggestion for an offer may be based on the determined acceptable margin and one or more pieces of data related to the REP. By extracting a first dataset that is associated with the REP and a second dataset that is associated with the seller of the REP, a predicted target margin that may be acceptable to the seller is determined as well as a cost basis against which this margin may be applied in developing an offer for the REP. This margin may be expressed with respect to one or more pieces of data related to the REP that are part of the first data set, e.g., the REP's original price, its original price plus repair costs, its original price plus repair costs along with carrying costs, and so forth. Once the margin is determined, an offer for purchasing the REP may suggested based on the first dataset and the predicted target margin desired by the seller.

FIG. 2 is an illustrative block diagram of a server 130 according to an embodiment. The server 130 includes a processing circuitry 210, a memory 220, a storage 230, a network interface 240, and an artificial intelligence (AI) processor 250. In an embodiment, the foregoing components of the server 130 may be communicatively coupled via a bus 260.

The processing circuitry 210 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), GPUs, general-purpose microprocessors, microcontrollers, digital signal processors (DSPs), and the like, or any other hardware logic components that can perform calculations or other manipulations of information.

The memory 220 may be volatile (e.g., RAM, etc.), non-volatile (e.g., ROM, flash memory, etc.), or a combination thereof. In one configuration, computer readable instructions to implement one or more embodiments disclosed herein may be stored in the storage 230.

In another embodiment, the memory 220 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 210, cause the processing circuitry 210 to perform the various processes described herein.

The storage 230 may be magnetic storage, optical storage, and the like, and may be realized, for example, as flash memory or other memory technology, CD-ROM, Digital Video Disks (DVDs), or any other medium which can be used to store the desired information.

The network interface 240 allows the server 130 to communicate with the user devices, web sources and data warehouse (shown in FIG. 1).

The AI processor 250 may be realized as one or more hardware logic components and circuits, including graphics processing units (GPUs), tensor processing units (TPUs), neural processing units, vision processing unit (VPU), reconfigurable field-programmable gate arrays (FPGA), and the like. These hardware logic components and circuits may be executing software. The AI processor 250 is configured to perform, for example, machine learning based on, for example, at least a portion of the abovementioned first dataset and second dataset.

It should be understood that the embodiments described herein are not limited to the specific architecture illustrated in FIG. 2, and other architectures may be equally used without departing from the scope of the disclosed embodiments.

According to an embodiment, the server 130 is configured to receive a request to generate a suggestion for a margin with regard to an REP or a suggestion as to what might be a suitable offer that a purchaser could propose to a seller for purchasing the REP from its current owner (e.g., a seller of the REP). The request may be received from a user device (e.g., the user device 120). The request may include initial information about the REP as well as initial information about the seller (i.e., owner) of the REP. The initial information may include a location pointer that is associated with the REP and the name of the seller (e.g., entity name), etc. The location pointer may be received from a user device 120, via for example, the App 125. The location pointer may be, for example, an address or a portion thereof or set of geographic coordinates for the real estate property, an indication of subdivision, gated community a floor, an apartment, a geo-location, and the like.

In an embodiment, the server 130 is configured to extract at least a first dataset that is associated with the at least one REP from at least one source (e.g., the web source 150) over the network 110. The first dataset may include, for example, information associated with prior transactions made with respect to the REP (e.g., the price in which the REP was purchased two years ago), information associated with prior transactions made with respect to other real-estate properties determined to be associated with the at least one REP, information associated with one or more second REPs in geographic proximity to the at least one REP, multimedia content (e.g., images, video) of the REP, and so on.

In an embodiment, the multimedia content element may be an overhead image of the location, at least one image of a map associated with the REP, interior pictures of the REP, exterior pictures of the REP, and the like. Such images may be retrieved from public sources, such as Google® maps, and similar sources.

In a further embodiment, the first dataset may include one or more values that are associated with a first set of parameters. The first set of parameters are parameters of the REP that are of a type that are useful for performing the valuation of the REP so that once a target margin of the seller is determined a predicted possible offer may be based thereon. For example, a parameter of the first set may be the price of the REP and value may be $80,000. As another example, a second parameter of the first set may be the address of the REP and value may be 1008 Lorrain St, Austin, Tex. 78703, USA. The first set of parameters may include for example, address, REP current value (i.e., current price), i.e., the price of the REP in its current state of repair, level of renovation needed, estimated renovation cost, time required for completing the renovation, and so on.

In an embodiment, the server 130 may be configured to determine an estimated after repair value (ARV) of the REP based on at least a portion for the first set of parameters and the values related thereto. It should be noted that the estimated ARV may be affected by the current state of the REP, the current value, the renovation plan of the REP, the estimated time for completing the renovation, the location (e.g., area, floor, etc.) of the REP, and so on.

In an embodiment, the server 130 is configured to extract, from at least one source (e.g., the web source 150), at least a second dataset that is associated with the seller (e.g., owner) of the at least a first REP. The second dataset may include, for example, the seller's name (e.g., entity name), previous transactions in which the seller was involved, financial information of the seller, business information, credit score, background information, and so on. In an embodiment, the second dataset includes one or more second values that are associated with a second set of parameters. The second set of parameters is a set of parameters related to the seller of the REP that is useful for determining a predicted desired target margin of the seller, as further discussed herein. For example, a parameter of the second set may be an average margin the seller has usually earned in REP transactions in the past and the value may be $20,000. As another example, a second parameter of the second set may be the average time the seller spent on renovating REPs and the value may be two months. The second set of parameters may include, for example, seller name, number of transactions made by the seller, credit score, and so on.

In an embodiment the server 130 is configured to determine a predicted desired target margin of the seller with respect to the sale of the at least one REP. The predicted desired target margin may be determined based on the second dataset. That is, the predicted target desired margin, as a percentage, is determined based on information related to the seller while the predicted target desired margin in absolute terms may further be the first dataset which contains information related to the REP. In an embodiment, the predicted desired target margin as a percentage may be determined based on past experience (e.g., previous known margin of the seller in REP transactions), while in absolute terms with regard to the instant REP, it may be also based on total renovation cost of the REP, purchase costs of the REP, and so on.

In an embodiment, in order to determine the predicted target desired margin of the seller, the server 130 is configured to apply a model, such as a machine learning model, to the second dataset. The model may be adapted to determine the predicted target desired margin of the seller with respect to the sale of the at least one REP, e.g., as a percentage. It may also take into account the first data set to determine the predicted target desired margin of the seller in absolute terms with regards to the instant REP. In one embodiment the functions of the AI processor 250 may be performed, in full or in part, by the processing circuitry 210 executing of a plurality of instructions stored in the memory 220. According to one embodiment, in order to determine the predicted target margin of the seller with respect to the sale of the at least a first REP, the model may be trained based on the values associated with the predetermined parameters of the second dataset.

As noted above, the first parameters (of the REP) may include for example and without limitation, address, REP current value (i.e., current price), level of renovation needed, estimated renovation cost, time required for completing the renovation, and so on. The second predetermined parameters related to the seller, who may be a property flipper, may include for example and without limitation, seller name, number of transactions made by the seller, credit score, financial information, and so on. The ML may be a supervised ML that is trained based on the abovementioned parameters, and in particular with regards to those of the second data set.

For example, the server 130 may determine that the predicted target margin of the seller is $20,000, or in a range between $15,000-$20,000 based on past experience (e.g., previous known margin of the seller in REP transactions), total renovation cost of the current REP and purchase costs of the current REP.

Thereafter, the server 130 may further generate a recommendation for an offer to be used by a potential buyer for purchasing the at least one REP based on the first dataset, and the predicted target margin of the seller. For example, the first dataset may indicate that the REP current value is $200,000. In addition, the first dataset may indicate that the estimated cost of the renovation needed is $20,000. The first dataset may also indicate that it would take one month to complete the renovation and that after renovation the REP estimated ARV would be $280,000. According to the same example, the second dataset may indicate the seller identity, the number of transactions made by the seller over the past three years, the seller credit score, and so on. According to the same example, the predicted target margin of the seller is $20,000 (based on the first dataset and the second dataset). Thus, the server 130 may be configured to generate a recommendation to consider purchasing the REP from the seller in $240,000.

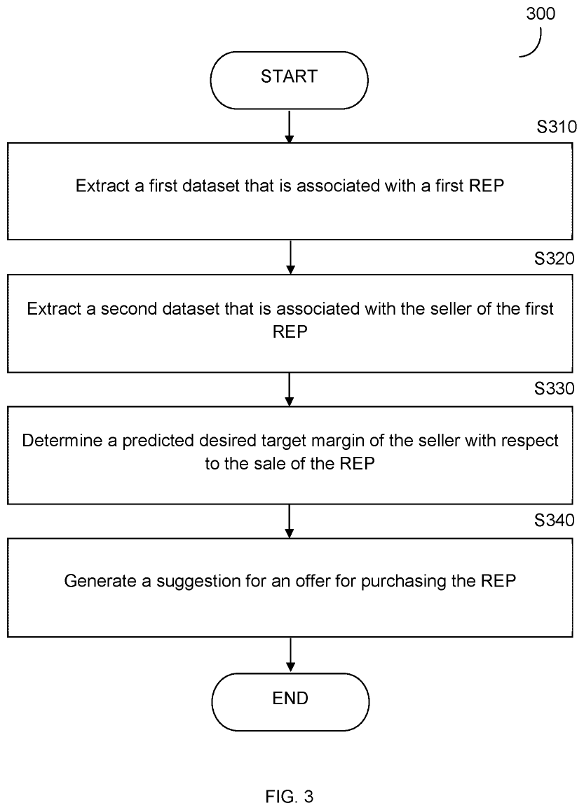

FIG. 3 shows an illustrative flowchart 300 describing a method for generating a predicted desired target margin of a seller of an REP, according to an embodiment. Based on the generated predicted desired target margin of the seller a suggest offer for purchasing the real-estate property (REP) may be suggest for use buyer.

At S310, a first dataset that is associated with at least a first REP is extracted from at least a source (e.g., the web source 150 of FIG. 1). The first dataset may contain values associated with parameters as described hereinabove.

At 320, a second dataset that is associated with the seller (e.g., owner) of the at least a first REP is extracted from at least a source (e.g., the web source 150). The second dataset may contain values associated with parameters as described hereinabove.

At S330, a predicted desired target margin of the seller with respect to the sale of the REP is determined. The predicted desired target margin may be determined based on the second dataset, e.g., as a percentage, or also based on the first dataset to obtain an absolute value. That is, the predicted desired target margin may be determined based on past experience (e.g., previous known margin of the seller in REP transactions), total renovation cost of the current REP, purchase costs of the current REP, and so on.

If the system has data specifically related to the seller, e.g., for use as the second data set, the system can analyze such information, e.g., previous transactions made by the seller. For example, the system can determine the margin obtained by the seller in his prior transactions which may take into account factors such as what the seller paid for each of his prior REPs, the amount of time the seller spent on renovating each of those, the cost of such renovations, and the selling price at which the seller sold each of the REPs so as to determine the margin for each REP. The system can then determine the predicted desired target margin, e.g., as a percentage, based on the average margin of such transactions. Such information can then be applied to the current REP based on factors in the first data set.

When the system does not have data specifically related to the seller, the system may search for an entity (i.e., company) by which the seller operates. If such is found the system can obtain information from public web sources for regarding the entity by which the seller operates and use those as if they were for the seller. Based on this information the system determines the predicted desired target margin.

Another factor that the system may employ in determining the predicted desired target margin is number of annual transactions made by the seller or an entity by which the seller operates. This factor may be used to adjust the predicted desired target margin as the margin obtained per transaction is usually lower when the number of transaction is larger.

The determined margin may be supplied to the requesting user, e.g., potential buyer, at one of user devices 120, e.g., via App 125 thereat.

At optional S340, a suggestion as to what might be a suitable offer for purchasing the REP is generated based on the extracted first dataset and the predicted target margin of the seller.

The determined suggestion may be supplied to the requesting user, e.g., potential buyer, at one of user devices 120, e.g., via App 125 thereat.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for generating a predicted desired target margin of a seller of a real-estate property (REP), comprising:
extracting at least a dataset that is associated with the seller of the at least a first REP, wherein the dataset includes at least one value that is associated with each parameter of a set of parameters related to at least one prior transaction of the seller; and
determining a predicted target margin of the seller with respect to the sale of the at least a first REP based on the second data set.

2. The method of claim 1, wherein, when at least one prior transaction of the seller is not available:
determining an entity associated with the seller, by which the seller engages in real estate transactions;
extracting at least a dataset that is associated with the entity, wherein the dataset associated with the entity includes at least one value that is associated with each parameter of a set of parameters related to prior transactions of the associated with the entity; and
employing the extracted parameters of the entity in lieu of the parameters of the seller.

3. The method of claim 1, wherein the determining of the predicted target desired margin of the seller is performed by applying a machine learning model to the dataset.

4. The method of claim 1, further comprising:
extracting at least a dataset that is associated with at least the REP wherein the dataset that is associated with the REP includes at least one value that is associated with a set of parameters related to the REP; and
developing a suggestion as to what might be an offer that a person could propose to the seller of the REP for purchase thereto based on the at least the dataset associated with the REP and the predicted desired target margin.

5. The method of claim 4, wherein the developing a suggestion as to what might be an offer that a person could propose is performed by applying a machine learning model to the dataset associated with the seller and to the dataset associated with the REP.

6. A non-transitory computer readable medium having stored thereon instructions for causing a processing circuitry to perform a process for generating a predicted desired target margin of a seller of a real-estate property (REP), the process comprising:
extracting at least a dataset that is associated with the seller of the at least a first REP, wherein the dataset includes at least one value that is associated with each parameter of a set of parameters related to prior transactions of the seller; and
determining a predicted target margin of the seller with respect to the sale of the at least a first REP based on the second data set.

7. A system for generating a predicted desired target margin of a seller of a real-estate property (REP), comprising:
a processing circuitry; and
a memory, the memory containing instructions that, when executed by the processing circuitry, configure the system to:
extract at least a dataset that is associated with the seller of the at least a first REP, wherein the dataset includes at least one value that is associated with each parameter of a set of parameters related to prior transactions of the seller; and
determine a predicted target margin of the seller with respect to the sale of the at least a first REP based on the second data set.

8. The system of claim 7, wherein, when at least one prior transaction of the seller is not available, the system is further configured to:
determine an entity associated with the seller, by which the seller engages in real estate transactions;
extract at least a dataset that is associated with the entity, wherein the dataset associated with the entity includes at least one value that is associated with each parameter of a set of parameters related to prior transactions of the associated with the entity; and
employ the extracted parameters of the entity in lieu of the parameters of the seller.

9. The system of claim 7, wherein determining of the predicted target desired margin of the seller is performed by the system applying a machine learning model to the dataset.

10. The system of claim 7, further the system is further configured to:
extract at least a dataset that is associated with at least the REP wherein the dataset that is associated with the REP includes at least one value that is associated with a set of parameters related to the REP; and
develop a suggestion as to what might be an offer that a person could propose to the seller of the REP for purchase thereto based on the at least the dataset associated with the REP and the predicted desired target margin.

11. The system of claim 10, wherein developing a suggestion as to what might be an offer that a person could propose is performed by the system applying a machine learning model to the dataset associated with the seller and to the dataset associated with the REP.
